(19) United States
(12) Patent Application Publication
(10) Pub. No.: US 2026/0332843 A1
(43) Pub. Date: Oct. 22, 2026

(54) LIVESTREAMING SPECIAL EFFECT GIFT GENERATION METHOD AND APPARATUS, DEVICE, AND STORAGE MEDIUM

(71) Applicant: Beijing Zitiao Network Technology Co., Ltd., Beijing (CN)

(72) Inventors: Ke Wang, Beijing (CN); Enjie ZHOU, Beijing (CN); Pingwei DENG, Beijing (CN); Haoan WANG, Beijing (CN)

(21) Appl. No.: 19/112,152

(22) PCT Filed: Sep. 15, 2023
(86) PCT No.: PCT/CN2023/119022

§ 371 Date: Mar. 14, 2025

(30) Foreign Application Priority Data
Sep. 16, 2022 (CN) 202211133067.3

(51) Int. Cl. H04N 21/431

(52) U.S. Cl. CPC H04N 21/4312

(57) ABSTRACT

A livestreaming effect gift generation method, apparatus, device and storage medium. The method comprises: obtaining basic data of a target effect gift, and generating a particle data file corresponding to the basic data (S110); generating a parameter configuration file according to the particle data file (S120); and sending the particle data file and the parameter configuration file as a resource package of the target effect gift to a livestreaming client, so that the livestreaming client generates, by means of rendering, the target effect gift in response to the target effect gift playback operation (S130).

### CROSS REFERENCE TO RELATED APPLICATIONS

This application claims the priority of the Chinese patent application filed with the China Patent Office on Sep. 16, 2023, with application number 202211133067.3, the content of which is incorporated herein by reference in its entirety.

### FIELD

The present disclosure relates to the field of livestreaming technology, for example, to a livestreaming effect gift generation method, apparatus, device, and storage medium.

### BACKGROUND

In livestreaming scenarios, the effect gift interaction function enriches the interactive methods of the livestreaming room and improves the user experience. However, the production cost of effect gifts is high and the generation efficiency is low.

### SUMMARY

The present disclosure provides a livestreaming effect gift generation method, apparatus, device, and storage medium.

The present disclosure embodiment provides a livestreaming effect gift generation method, comprising:
obtaining the basic data of the target effect gift, and generating a particle data file corresponding to the basic data;
generating a parameter configuration file according to the particle data file;
sending the particle data file and the parameter configuration file as a resource package of the target effect gift to the livestreaming client, so that the livestreaming client generating, by means of rendering, the target effect gift in response to the target effect gift playback operation.

The present disclosure embodiment also provides a livestreaming effect gift generation method, comprising:
in response to the target effect gift playback operation, obtaining a resource package corresponding to the target effect gift playback operation, wherein the resource package includes: the particle data file and the parameter configuration file of the target effect gift;
loading the particle data file and the parameter configuration file, and generating, by means of rendering, the target effect gift.

The disclosed embodiment also provides an apparatus for generating a livestreaming effect gift, including:
a first file generation module, configured to obtain basic data of a target effect gift and generate a particle data file corresponding to the basic data;
a second file generation module, configured to generate a parameter configuration file according to the particle data file;
a resource sending module, configured to send the particle data file and the parameter configuration file as a resource package of the target effect gift to the livestreaming client, so that the livestreaming client generates, by means of rendering, the target effect gift in response to the target effect gift playback operation.

The disclosed embodiment also provides an apparatus for generating a livestreaming effect gift, including:
a resource obtaining module, configured to obtain a resource package corresponding to the target effect gift playback operation in response to the target effect gift playback operation, wherein the resource package includes: a particle data file and a parameter configuration file of the target effect gift;
an effect gift generation module, configured to load the particle data file and the parameter configuration file, and generate, by means of rendering, the target effect gift.

The disclosed embodiment also provides an electronic device, including:
one or more processors;
a memory, configured to store one or more programs,
when the one or more programs are executed by the one or more processors, the one or more processors are caused to implement the livestreaming effect gift generation method as described in the disclosed embodiment.

The embodiment of the present disclosure also provides a computer-readable storage medium, on which a computer program is stored. When the computer program is executed by a processor, the livestreaming effect gift generation method as described in the embodiment of the present disclosure is implemented.

### BRIEF DESCRIPTION OF THE FIGURES

FIG. 1 is a flowchart of a livestreaming effect gift generation method provided by an embodiment of the present disclosure;

FIG. 2 is a flowchart of a livestreaming effect gift generation method provided by an embodiment of the present disclosure;

FIG. 3 is a flowchart of generating a particle data file provided by an embodiment of the present disclosure;

FIG. 4 is a flowchart of generating a parameter configuration file provided by an embodiment of the present disclosure;

FIG. 5 is a flowchart of a livestreaming effect gift generation method provided by an embodiment of the present disclosure;

FIG. 6 is a flowchart of generating a rendering effect diagram of an effect gift provided by an embodiment of the present disclosure;

FIG. 7 is a display effect of an effect gift in a livestreaming room page provided by an embodiment of the present disclosure;

FIG. 8 is a flowchart of rendering an effect gift provided by an embodiment of the present disclosure;

FIG. 9 is a schematic diagram of the structure of an apparatus for generating a livestreaming effect gift provided by an embodiment of the present disclosure;

FIG. 10 is a schematic diagram of the structure of an apparatus for generating a livestreaming effect gift provided by an embodiment of the present disclosure;

FIG. 11 is a schematic diagram of the structure of an electronic device provided by an embodiment of the present disclosure.

### DETAILED DESCRIPTION OF EMBODIMENTS

The following will describe embodiments of the present disclosure with reference to the accompanying drawings. Although some embodiments of the present disclosure are shown in the accompanying drawings, the present disclosure can be implemented in various forms and should not be construed as being limited to the embodiments described herein. Instead, these embodiments are provided to understand the present disclosure. The drawings and embodiments of the present disclosure are only for exemplary purposes and are not intended to limit the scope of protection of the present disclosure.

The multiple steps described in the method implementation of the present disclosure can be performed in different orders and/or in parallel. In addition, the method implementation may include additional steps and/or omit the steps shown. The scope of the present disclosure is not limited in this respect.

The term “including” and its variations used herein are open inclusions, i.e., “including but not limited to”. The term “based on” means “based at least in part”. The term “one embodiment” means “at least one embodiment”; the term “another embodiment” means “at least one other embodiment”; the term “some embodiments” means “at least some embodiments”. The relevant definitions of other terms will be given in the following description.

The concepts of “first”, “second”, etc. mentioned in the present disclosure are only used to distinguish different apparatus, modules or units, and are not used to limit the order or interdependence of the functions performed by these apparatus, modules or units.

The modifiers “one” and “multiple” mentioned in the present disclosure are illustrative rather than restrictive, and should be understood as “one or more” unless otherwise specified in the context.

The names of the messages or information exchanged between the multiple devices in the embodiments of the present disclosure are only for illustrative purposes, and are not used to limit the scope of these messages or information.

Before using the technical solutions disclosed in multiple embodiments of the present disclosure, the type, scope of use, and usage scenarios of the personal information involved in the present disclosure should be informed to the user and the user's authorization should be obtained in an appropriate manner in accordance with relevant laws and regulations.

For example, in response to receiving an active request from the user, a prompt message is sent to the user to clearly prompt the user that the operation requested to be performed will require to obtain and use the user's personal information. Thus, the user can autonomously choose whether to provide personal information to the electronic device, application, server, storage medium, or other software or hardware that performs the operation of the technical solution of the present disclosure according to the prompt message.

As an optional but non-limiting implementation method, in response to receiving an active request from the user, the method of sending the prompt message to the user can be, for example, a pop-up window, and the prompt message can be presented in text in the pop-up window. In addition, the pop-up window can also carry a selection control for the user to choose “agree” or “disagree” to provide personal information to the electronic device.

The above notification and the process of obtaining user authorization are only illustrative and do not constitute a limitation on the implementation of the present disclosure. Other methods that meet relevant laws and regulations may also be applied to the implementation of the present disclosure.

The data involved in this technical solution (including the data itself, the obtaining or use of the data) shall comply with the requirements of relevant laws and regulations and relevant provisions.

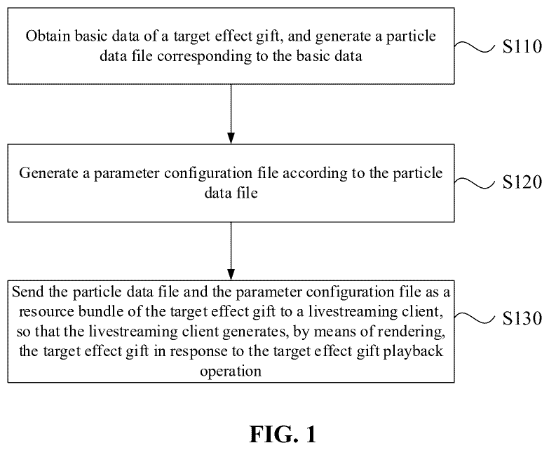

FIG. 1 is a flow chart of a livestreaming effect gift generation method provided by an embodiment of the present disclosure. The embodiment of the present disclosure is applicable to the situation where a resource package of a livestreaming effect gift is quickly generated in a front-end editor according to the input picture or text. The method can be executed by a livestreaming effect gift generation apparatus, which can be implemented in the form of software and/or hardware, for example, by an electronic device, which can be a mobile terminal with a front-end editor installed, and a personal computer (PC) terminal. As shown in FIG. 1, the method includes the following steps.
S110, obtain the basic data of the target effect gift, and generate a particle data file corresponding to the basic data.

Among them, a gift refers to a virtual item object used to give to others, an effect gift refers to a non-static virtual item object, and the expression form of the effect gift includes fireworks, flames, water flow, smoke, and fog, etc. The target effect gift can be any effect gift in a specified form, such as fireworks.

Among them, the basic data of the target effect gift includes: at least one of a picture, or a combination of text and font package, which is used to indicate the display effect of the target effect gift, such as the content (pattern, text), style, etc. of the gift display. Exemplarily, taking fireworks as an example, if the target effect gift is a firework with a specified pattern, such as a heart-shaped pattern firework, the basic data of the target effect gift can be a picture containing a heart-shaped pattern firework; if the target effect gift is a firework with specific text, such as the official script firework of “Happy New Year”, the basic data of the target effect gift can be a combination of the text “Happy New Year” and the official script font package; if the target effect gift is to include both the specified pattern and the specified text, such as a combination fireworks of heart-shaped firework and official script firework of “Happy New Year”, the basic data of the target effect gift can include a picture containing a heart-shaped pattern firework, and a combination of the text “Happy New Year” and the official script font package.

Among them, the particle data file generally refers to a binary bin file, and the particle data file includes multiple target particles used to render the target effect gift. The target particles are specific pixels selected from the grayscale picture after grayscale image processing of the basic data.

In this embodiment, the basic data of the target effect gift can be sent by the livestreaming client to the front-end editor. For example, after the anchor or the audience clicks the effect gift customization button in the livestreaming room page of the livestreaming client, they upload pictures or enter text and font packages in the pop-up operation page, and the livestreaming client sends the pictures uploaded by the user or the text and font packages entered as the basic data of the target effect gift to the front-end editor. The basic data of the target effect gift can also be directly uploaded to the front-end editor by the designer as needed.

In this embodiment, after obtaining the basic data of the target effect gift, the basic data is processed into a grayscale picture, and according to the grayscale value of the pixel points in the grayscale picture, the target particles that can display the specified pattern or specified text in the basic data are selected from the grayscale picture, and packaged to generate a particle data file.

In this embodiment, a particle data file capable of rendering a rough effect gift can be generated by simply inputting a picture or text and font package in the front-end editor, without processing a complex model file including a large number of pictures corresponding to the effect gift, so the production cost of the effect gift can be effectively reduced.
S120, generate a parameter configuration file according to the particle data file.

Among them, the parameter configuration file includes effect parameters of multiple target particles in the particle data file, which are used to indicate the changes of the target particles in multiple dimensions during the playback of the effect gift, such as the color, displacement, size, etc. of the particles, so as to improve the degree of detail restoration of the target effect gift, such as the color change, size change, and explosion effect of fireworks when the fireworks explode in the air.

In this embodiment, after obtaining the particle data file, a particle rendering tool, such as a particle system, is used to render the particle data file to obtain an initial effect gift with limited degree of detail restoration, such as a heart-shaped firework with a blurred outline. In order to restore the details of the initial effect gift and obtain the target effect gift that meets the requirements, the effect parameters of multiple target particles in the particle data file can be adjusted on the basis of the initial effect gift, such as the size, color, explosion effect, etc. of the target particles, and the effect parameters of the multiple target particles finally determined are packaged to generate a parameter configuration file.
S130, send the particle data file and the parameter configuration file as a resource package of the target effect gift to the livestreaming client, so that the livestreaming client generates, by means of rendering, the target effect gift in response to the target effect gift playback operation.

In this embodiment, since the generation of the target effect gift that meets the standard requires the simultaneous loading of the particle data file and the parameter configuration file, the particle data file and the parameter configuration file can be sent as the resource package of the target effect gift to multiple livestreaming clients for caching. Thus, for the livestreaming client that sends the basic data of the target effect gift, the particle data file and the parameter configuration file are immediately loaded, and the corresponding target effect gift is generated and played in the livestreaming room where the target effect gift playback operation is detected, such as playing heart-shaped fireworks. At the same time, multiple livestreaming clients that receive the particle data file and parameter configuration file can provide icons of target effect gifts corresponding to the patterns or texts in the basic data, such as icons of heart-shaped fireworks, in the livestreaming page to create an interactive atmosphere for gifts.

The technical solution of the disclosed embodiment obtains the basic data of the target effect gift and generates a particle data file corresponding to the basic data; generates a parameter configuration file according to the particle data file; sends the particle data file and the parameter configuration file as a resource package of the target effect gift to the livestreaming client, so that the livestreaming client generates, by means of rendering, the target effect gift in response to the target effect gift playback operation. It solves the problem of high production cost of effect gifts, reduces the production cost of livestreaming effect gifts, and improves the production efficiency of effect gifts.

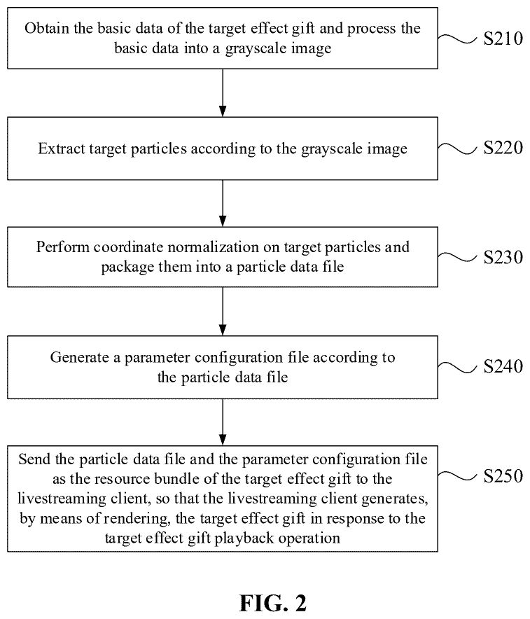

FIG. 2 is a flow chart of a livestreaming effect gift generation method provided by the disclosed embodiment. Based on the above embodiment, the disclosed embodiment provides the step of obtaining the basic data of the target effect gift and generating a particle data file corresponding to the basic data, and the step of generating a parameter configuration file according to the particle data file. Referring to FIG. 2, the method is applied to the front-end editor and includes the following steps.
S210, obtain the basic data of the target effect gift and processing the basic data into a grayscale picture.

Among them, the basic data refers to the data input into the front-end editor for generating the resource package of the target effect gift, including: at least one of pictures, a combination of text and font packages. A grayscale picture refers to a picture represented by a grayscale value. Each pixel in the grayscale picture uses a value between 0 and 255 to represent the color, 0 represents black, 255 represents white, and the intermediate value is different levels of gray. A pixel is the smallest unit of a picture, and a picture is composed of a large number of pixels.

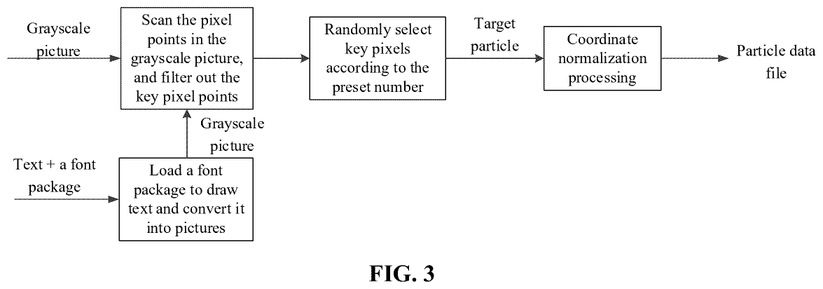

In this embodiment, the basic data can be divided into two types of data: pictures, or a combination of text and font packages, and these two types of data are pre-processed in different ways. As shown in FIG. 3, if the basic data is a combination of text and font packages, the font packages are loaded to draw the text and the drawn text is converted into a picture. If the picture is a color picture at this time, for example, the font color is blue, a pre-set grayscale processing method is used to process the picture into a grayscale picture. Among them, the grayscale processing method can be a floating point method, an integer method, a shift method, an average method, etc. If the picture is a grayscale picture at this time, for example, the font color is black, no other processing is performed on the picture. Similarly, if the basic data is a color picture, a pre-set grayscale processing method is used to process the picture into a grayscale picture. If the basic data is a grayscale picture, no other processing is performed on the picture.
S220, extract target particles according to the grayscale picture.

Wherein, the target particles refer to specific pixels selected from the grayscale picture for rendering the target effect gift according to the grayscale value of the pixel, such as pixels that can render fireworks effect.

Optionally, extracting target particles according to the grayscale picture includes: scanning the pixels in the grayscale picture and selecting key pixels, wherein the key pixels are pixels with grayscale values meeting a grayscale threshold condition; randomly selecting a specified number of key pixels as target particles.

In this embodiment, the grayscale picture can be drawn on a canvas, such as drawn on a canvas, extracting image data in the canvas, such as the coordinates and grayscale values of multiple pixels, and selecting pixels that meet the grayscale threshold condition, such as selecting pixels whose grayscale values are less than 100 as key pixels that can display gift effect. Since the number of key pixels selected in this step is relatively large, and only a small number of pixels, such as 2000 to 5000 pixels, need to be loaded when rendering gift effect, the number of key pixels can be optimized by random selection according to the preset number of particles, for example, 4000 key pixels are randomly selected from the selected key pixels as target particles.
S230, perform coordinate normalization on target particles and packaging them into a particle data file.

In this embodiment, since the picture size of the basic data may be relatively large, and the size of the display area of the target effect gift in the livestreaming page is relatively small, in order to ensure that the positions of all target particles can be constrained within the display area specified in the livestreaming room page during actual rendering, the coordinates of all target particles need to be normalized, that is, the coordinates of the target particles are mapped to the specified interval. The information of the normalized target particles, such as particle number, size, coordinates, and grayscale value, is packaged to generate a particle data file.

Exemplarily, performing coordinate normalization on target particles may include: determining the size of the minimum enclosing interval of all target particles, that is, calculating the difference between the maximum and minimum values of the horizontal coordinates of all target particles as the interval length, and calculating the difference between the maximum and minimum values of the vertical coordinates of all target particles as the interval width. Similarly, the length and width of the display area of the target effect gift in the livestreaming page are calculated. Calculating the first ratio of the minimum enclosing interval length to the display area length, and dividing the horizontal coordinates of multiple target particles by the first ratio to achieve the normalization of the horizontal coordinates of the target particles. Calculating the second ratio of the minimum enclosing interval width to the display area width, and dividing the vertical coordinates of multiple target particles by the second ratio to achieve the normalization of the vertical coordinates of the target particles. Thus, all target particles are restricted to an area of the same size as the display area of the target effect gift in the livestreaming page.
S240, generate a parameter configuration file according to the particle data file.

Among them, the parameter configuration file includes the effect parameters of multiple target particles in the particle data file, which are used to indicate the changes in the parameters such as color, displacement, size, etc. of the target particles during the playback of the effect gift, so as to restore the details of the target effect gift, such as the color change, fading and dimming, position change, etc. of the fireworks when they explode in the air.

Among them, the front-end editor can be divided into two parts according to the function, where one part is used to generate a particle data file according to the grayscale picture corresponding to the basic data, and the other part is used to generate a parameter configuration file according to the particle data file.

Optionally, generating a parameter configuration file according to the particle data file includes: rendering the particle data file using a particle rendering tool to obtain an initial effect gift; determining the effect parameters of multiple target particles in the particle data file in response to the configuration operation of the initial effect gift; the effect parameters include: color, size, displacement, brightness and particle level effect; and packaging the effect parameters of multiple target particles to generate a parameter configuration file.

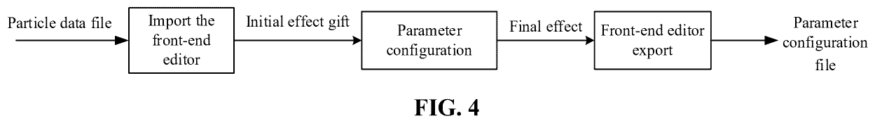

In this embodiment, as shown in FIG. 4, the particle data file can be imported into the front-end editor, and a particle rendering tool, such as a particle system, is used to render and obtain an initial effect gift with limited degree of detail restoration, such as a circular firework, based on the default effect parameters. According to the parameter configuration operation performed by the designer on all target particles based on the initial effect gift, the effect parameters of multiple target particles, such as color, size, displacement, brightness, explosion effect, particle level effect, etc., are determined, and the configured effect parameters are exported as a parameter configuration file for subsequent rendering of the target effect gift.

For example, taking fireworks as an example, for the particle color parameter, if the target effect gift is a red firework, the particle color can be configured to be red; if the target effect gift is a red-to-purple firework, the particle color can be configured to be red at the explosion time, to be purple Is after the explosion, and so on. For the particle size parameter, a smaller size can be configured for the target particle before the firework explodes, and a larger size can be configured for the target particle after the firework explodes, so that the specified effect is achieved when the firework explodes. For the particle displacement parameter, the moving trajectory of the target particle during the entire process of playing the firework effect can be configured, that is, the moving trajectory of the firework during the playing process can be determined. For brightness parameters, the properties of the target particles such as fading and dimming during the fireworks playback process can be configured, so that the fireworks explosion presents a dazzling and then gradually disappearing effect. For explosion effect parameters, the explosion time and continuous display time can be configured. For particle level effect parameters, such as secondary particle effect parameters, particle animation at the same level as achieved through animation can be configured to render the fireworks effect.

Among them, if the target effect gift includes multiple rendering objects, the multiple rendering objects can be arranged during parameter configuration to achieve the specified effect. For example, if the target effect gift includes five circular fireworks, the display positions of the five circular fireworks can be configured so that the five circular fireworks form a specified shape, such as the shape of a flower; the explosion time of the five circular fireworks can also be configured so that the five circular pattern fireworks explode one after another.
S250, send the particle data file and the parameter configuration file as the resource package of the target effect gift to the livestreaming client, so that the livestreaming client generates, by means of rendering, the target effect gift in response to the target effect gift playback operation.

The technical solution of the embodiment of the present disclosure is to input at least one of the picture corresponding to the target effect gift, or the combination of the text and the font package into the front-end editor, extract the target particles corresponding to the target effect gift using the grayscale picture, and generate a particle data file; then configure the parameters of multiple target particles in the particle data file to generate a parameter configuration file; send the particle data file and the parameter configuration file as the resource package of the target effect gift to the livestreaming client, so that the livestreaming client generates, by means of rendering, the target effect gift in response to the target effect gift playback operation, which solves the problem of high production cost of effect gifts. By uploading a picture or text and font package in the front-end editor, the production cost of livestreaming effect gifts can be reduced and the production efficiency of effect gifts can be improved.

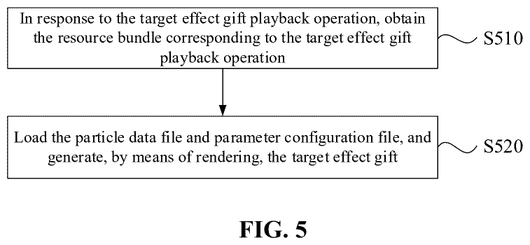

FIG. 5 is a flow chart of a livestreaming effect gift generation method provided by the embodiment of the present disclosure. The embodiment of the present disclosure is applicable to the situation where a resource package is loaded in the livestreaming client and an effect gift is quickly generated in the livestreaming room. The method can be executed by an apparatus for generating livestreaming effect gifts, which can be implemented in the form of software and/or hardware, for example, by an electronic device, which can be a mobile terminal and a PC terminal installed with a livestreaming client. As shown in FIG. 5, the method includes the following steps.
S510, in response to the target effect gift playback operation, obtain the resource package corresponding to the target effect gift playback operation.

Wherein, the resource package includes: a particle data file and a parameter configuration file of the target effect gift. The particle data file includes multiple target particles for rendering the target effect gift, and the target particles are specific pixels selected from the grayscale picture after grayscale processing of the basic data. The parameter configuration file includes the effect parameters of multiple target particles in the particle data file, which are used to indicate the changes of the target particles in multiple dimensions during the effect gift playback process, such as the color, displacement, size, etc. of the particles, so as to improve the degree of detail restoration of the target effect gift, such as the color change, size change, and explosion effect of fireworks when the fireworks explode in the air.

In this embodiment, the livestreaming room page can display icons of multiple pre-designed effect gifts, such as the icon of red star pattern fireworks, the icon of yellow star pattern fireworks, the icon of blue fireworks, the icon of waves, etc. When the user clicks on the icon of one of the effect gifts and purchases the effect gift, the resource package corresponding to the effect gift is obtained from the local cache.

Among them, the resource package can be the resource package that the front-end editor actively sends to the livestreaming client for caching after generating the resource package corresponding to the basic data of the effect gift, or the resource package that the livestreaming client has previously requested from the front-end editor which corresponds to the basic data of the effect gift and stored in the local cache.

In this embodiment, an effect gift customization button, such as a fireworks customization button, can also be provided in the livestreaming room page for users to customize effect gifts, such as customizing avatar fireworks. When the user clicks the effect gift customization button in the livestreaming room page, the gift customization operation page can pop up, and obtain a picture containing a gift effect uploaded by the user in the gift customization operation page, such as a picture containing an avatar, or the input gift copy and the selected font package. The livestreaming client sends the picture uploaded by the user or the input text and font package as the basic data of the specified effect gift to the front-end editor, and receives the resource package of the specified effect gift returned by the front-end editor.

In this embodiment, by obtaining a picture or text and font package input by the user in the front-end editor, a resource package that can render the user-customized target effect gift can be quickly obtained, which can effectively reduce the production cost of effect gifts, promote live interaction, and enrich the types of effect gifts.
S520, load the particle data file and parameter configuration file, and generate, by means of rendering, the target effect gift.

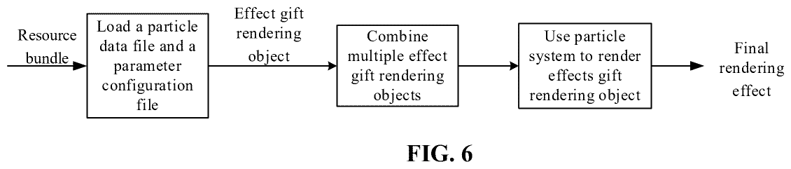

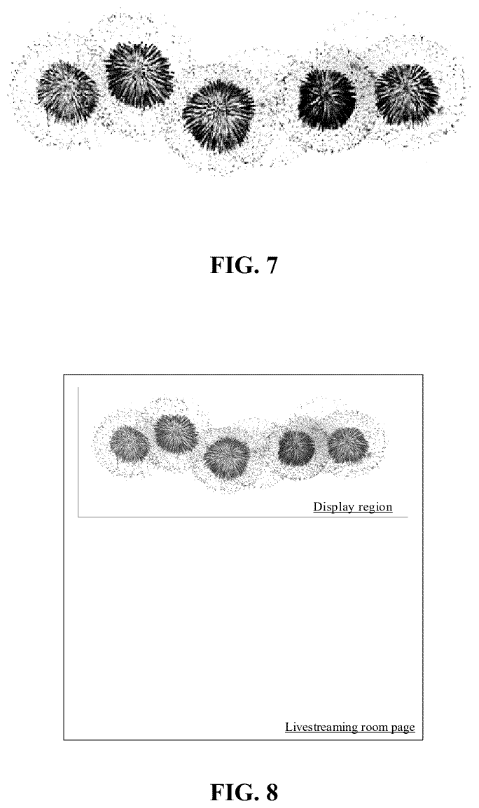

In this embodiment, after obtaining the resource package corresponding to the basic data of the target effect gift, if the user needs to play the target effect gift, the particle data file and parameter configuration file in the resource package are immediately loaded, and the specified effect gift is generated, by means of rendering, such as the fireworks effect gift shown in FIG. 6, and the specified effect gift is played in the specified display area of the livestreaming room, such as playing the fireworks effect gift in the display area of the livestreaming room page shown in FIG. 7.

Among them, the effect gift display area in the livestreaming room page can be set at the top of the livestreaming room page, or in the middle of the livestreaming room page, or at other positions in the livestreaming room page that will not block the anchor screen, or, for different types of effect gifts, corresponding display areas can be set in the livestreaming room page. For example, the display area of the fireworks effect gift is at the top of the livestreaming room page, and the display area of the flame effect gift is in the middle of the livestreaming room page, etc. In this embodiment, the position of the display area can be adjusted as needed.

Optionally, loading the particle data file and the parameter configuration file, generating, by means of rendering, the target effect gift, includes: loading the particle data file and the parameter configuration file, generating at least one effect gift rendering object; combining at least one effect gift rendering object, and generating, by means of rendering, the target effect gift by using the particle rendering tool.

In this embodiment, as shown in FIG. 8, by loading the particle data file and the parameter configuration file in the resource package, at least one effect gift rendering object, such as a fireworks rendering object, can be generated. At this time, the effect gift rendering object already has the ability to render effects independently. If the parameter configuration file includes the position arrangement of multiple effect gift rendering objects, multiple effect gift rendering objects can be combined according to the position arrangement result, and then a particle rendering tool, such as a particle system, is used to render the combined effect gift rendering object to generate the target effect gift. Among them, if the parameter configuration file includes particle level effect parameters, the target effect gift can be rendered in conjunction with the particle animation of the same level realized by animation.

Among them, this embodiment adds a generation path for effect gifts. By uploading pictures or entering text in the front-end editor, generating a particle data file and a parameter configuration file, and loading the particle data file and the parameter configuration file in the livestreaming client to generate, by means of rendering, effect gifts played in the live room, the operation cost is low and the effect of the gift is controllable, which can effectively promote participation in live interaction.

The technical solution of the disclosed embodiment is applied to the livestreaming client. By responding to the target effect gift playback operation, a resource package corresponding to the target effect gift playback operation is obtained; the resource package includes: the particle data file and the parameter configuration file of the target effect gift; the particle data file and the parameter configuration file are loaded, and the target effect gift is generated, by means of rendering. It solves the problem of high production cost of effect gifts, and achieves reduction of the production cost of livestreaming effect gifts, and improves the production efficiency of effect gifts.

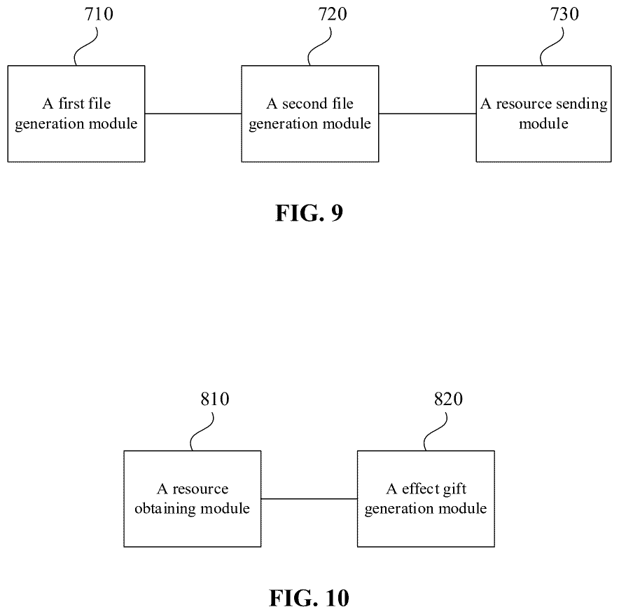

FIG. 9 is a structural schematic diagram of a livestreaming effect gift generation apparatus provided by the disclosed embodiment. As shown in FIG. 9, the apparatus is applied to the front-end editor, including: a first file generation module 710, a second file generation module 720 and a resource sending module 730.

The first file generation module 710 is configured to obtain the basic data of the target effect gift and generate a particle data file corresponding to the basic data;
the second file generation module 720 is configured to generate a parameter configuration file according to the particle data file;
the resource sending module 730 is configured to send the particle data file and the parameter configuration file as the resource package of the target effect gift to the livestreaming client, so that the livestreaming client generates, by the means of rendering, the target effect gift, in response to the target effect gift playback operation.

In the technical solution provided by the disclosed embodiment, the livestreaming effect gift generation apparatus obtains the basic data of the target effect gift and generates a particle data file corresponding to the basic data; generates a parameter configuration file according to the particle data file; sends the particle data file and the parameter configuration file as the resource package of the target effect gift to the livestreaming client, so that the livestreaming client generates, by the means of rendering, the target effect gift, in response to the target effect gift playback operation. It solves the problem of high production cost of effect gifts, reduces the production cost of livestreaming effect gifts, and improves the production efficiency of effect gifts.

In the above scheme, the first file generation module 710 includes:
a data processing unit, configured to obtain the basic data of the target effect gift, and process the basic data into a grayscale picture;
a particle extraction unit, configured to extract the target particles according to the grayscale picture;
a coordinate processing unit, configured to normalize the coordinates of the target particles, and package the information of the normalized target particles into a particle data file.

In the above scheme, the particle extraction unit is configured to: scan the pixel points in the grayscale picture, and select the key pixel points with grayscale values meeting grayscale threshold conditions; and randomly select a specified number of key pixel points as target particles.

In the above scheme, the second file generation module 720 is configured to:
render the particle data file using a particle rendering tool to obtain an initial effect gift;
in response to the configuration operation of the initial effect gift, determine the effect parameters of multiple target particles in the particle data file; the effect parameters include: color, size, displacement, brightness, and particle level effect;
package the effect parameters of multiple target particles to generate a parameter configuration file.

The livestreaming effect gift generation apparatus provided in the embodiment of the present disclosure can execute the livestreaming effect gift generation method applied to the front-end editor provided in any embodiment of the present disclosure, and has the functional modules and effects corresponding to the execution method.

The multiple units and modules included in the above-mentioned apparatus are only divided according to the functional logic, but are not limited to the above-mentioned division, as long as the corresponding functions can be realized; in addition, the names of the multiple functional units are only for the convenience of mutual distinction, and are not used to limit the protection scope of the embodiment of the present disclosure.

FIG. 10 is a structural schematic diagram of a livestreaming effect gift generation apparatus provided in the embodiment of the present disclosure. As shown in FIG. 10, the apparatus is applied to the livestreaming client, including: a resource obtaining module 810 and an effect gift generation module 820.

The resource obtaining module 810 is configured to obtain the resource package corresponding to the target effect gift playback operation in response to the target effect gift playback operation; the resource package includes: the particle data file and parameter configuration file of the target effect gift;

The effect gift generation module 820 is configured to load the particle data file and the parameter configuration file, and generate, by means of rendering, the target effect gift.

In the technical solution provided by the embodiment of the present disclosure, the apparatus for generating livestreaming effect gifts is applied to the livestreaming client, and in response to the target effect gift playback operation, a resource package corresponding to the target effect gift playback operation is obtained; the resource package includes: the particle data file and parameter configuration file of the target effect gift; the particle data file and the parameter configuration file are loaded, and the target effect gift is generated, by means of rendering. It solves the problem of high production cost of effect gifts, reduces the production cost of livestreaming effect gifts, and improves the production efficiency of effect gifts.

In the above scheme, the effect gift generation module 820 is configured to: load the particle data file and the parameter configuration file to generate at least one effect gift rendering object; combine at least one effect gift rendering object, and generate, by means of rendering, the target effect gift by using the particle rendering tool.

The apparatus for generating livestreaming effect gifts provided by the embodiment of the present disclosure can execute the livestreaming effect gift generation method applied to the livestreaming client provided by any embodiment of the present disclosure, and has the functional modules and effects corresponding to the execution method.

The multiple units and modules included in the above apparatus are only divided according to the functional logic, but are not limited to the above division, as long as the corresponding functions can be realized; in addition, the names of the multiple functional units are only for the convenience of distinguishing each other, and are not used to limit the protection scope of the embodiment of the present disclosure.

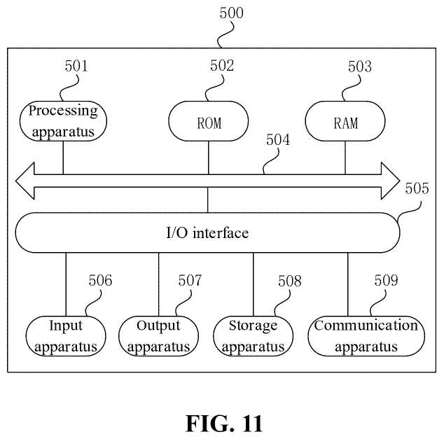

FIG. 11 is a schematic diagram of the structure of an electronic device provided in an embodiment of the present disclosure. Referring to FIG. 11 below, it shows a schematic diagram of the structure of an electronic device (such as a terminal device or server in FIG. 11) 500 suitable for implementing an embodiment of the present disclosure. The terminal device in the embodiment of the present disclosure may include mobile terminals such as mobile phones, laptop computers, digital broadcast receivers, personal digital assistants (PDAs), tablet computers (Portable Android Devices, PADs), portable multimedia players (Portable Media Players, PMPs), vehicle-mounted terminals (such as vehicle-mounted navigation terminals), etc., and fixed terminals such as digital televisions (TVs), desktop computers, etc. The electronic device shown in FIG. 11 is only an example and should not bring any limitations to the functions and scope of use of the embodiments of the present disclosure.

As shown in FIG. 11, the electronic device 500 may include a processing apparatus (e.g., a central processing unit, a graphics processing unit, etc.) 501, which may perform various appropriate actions and processes according to a program stored in a read-only memory (ROM) 502 or a program loaded from a storage device 508 to a random access memory (RAM) 503. In the RAM 503, various programs and data required for the operation of the electronic device 500 are also stored. The processing apparatus 501, the ROM 502, and the RAM 503 are connected to each other via a bus 504. An input/output (I/O) interface 505 is also connected to the bus 504.

The following devices may be connected to the I/O interface 505: input apparatus 506 including, for example, a touch screen, a touchpad, a keyboard, a mouse, a camera, a microphone, an accelerometer, a gyroscope, etc.; output apparatus 507 including, for example, a liquid crystal display (LCD), a speaker, a vibrator, etc.; storage apparatus 508 including, for example, a tape, a hard disk, etc.; and communication apparatus 509. The communication apparatus 509 may allow the electronic device 500 to communicate with other devices wirelessly or wired to exchange data. Although FIG. 11 shows an electronic device 500 having a variety of apparatus, it is not required to implement or have all the apparatus shown. More or fewer apparatus may be implemented or equipped alternatively.

According to an embodiment of the present disclosure, the process described above with reference to the flowchart may be implemented as a computer software program. For example, an embodiment of the present disclosure includes a computer program product including a computer program carried on a non-transitory computer-readable medium, the computer program including a program code for executing the method shown in the flowchart. In such an embodiment, the computer program can be downloaded and installed from the network through the communication apparatus 509, or installed from the storage apparatus 508, or installed from the ROM 502. When the computer program is executed by the processing apparatus 501, the above functions defined in the method of the embodiment of the present disclosure are executed.

The names of the messages or information exchanged between the multiple apparatus in the embodiment of the present disclosure are only for illustrative purposes, and are not used to limit the scope of these messages or information.

The electronic device provided in the embodiment of the present disclosure and the livestreaming effect gift generation method provided in the above embodiment belong to the same concept. The technical details not described in detail in this embodiment can be referred to the above embodiment, and this embodiment has the same effect as the above embodiment.

The embodiment of the present disclosure provides a computer storage medium, on which a computer program is stored, and when the computer program is executed by the processor, the livestreaming effect gift generation method provided in the above embodiment is implemented.

The above-mentioned computer-readable medium of the present disclosure can be a computer-readable signal medium or a computer-readable storage medium or any combination of the above two. The computer-readable storage medium can be, for example, an electrical, magnetic, optical, electromagnetic, infrared, or semiconductor system, apparatus or devices, or any combination of the above. Computer-readable storage media may include: an electrical connection with one or more conductors, a portable computer disk, a hard disk, RAM, ROM, an erasable programmable read-only memory (EPROM), flash memory, optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, apparatus or device. In the present disclosure, a computer-readable signal medium may include a data signal propagated in a baseband or as part of a carrier wave, which carries a computer-readable program code. Such propagated data signals may take a variety of forms, including electromagnetic signals, optical signals, or any suitable combination of the above. A computer-readable signal medium may also be any computer-readable medium other than a computer-readable storage medium, which may send, propagate, or transmit a program for use by or in combination with an instruction execution system, device, or device. The program code contained on the computer-readable medium can be transmitted using any appropriate medium, including: wires, optical cables, radio frequencies (RF), etc., or any suitable combination of the above. The storage medium can be a non-transitory storage medium.

In some embodiments, the client and the server can communicate using any currently known or future developed network protocol such as HyperText Transfer Protocol (HTTP), and can be interconnected with any form or medium of digital data communication (e.g., communication network). Examples of communication networks include local area networks (LAN), wide area networks (WAN), internets (e.g., the Internet), and peer-to-peer networks (e.g., ad hoc peer-to-peer networks), as well as any currently known or future developed networks.

The above-mentioned computer-readable medium can be contained in the above-mentioned electronic device; or it can exist separately without being assembled into the electronic device.

The computer-readable medium carries one or more programs. When the one or more programs are executed by the electronic device, the electronic device: obtains the basic data of the target effect gift and generates a particle data file corresponding to the basic data;
generates a parameter configuration file according to the particle data file;
sends the particle data file and the parameter configuration file as a resource package of the target effect gift to the livestreaming client, so that the livestreaming client generates, by means of rendering, the target effect gift in response to the target effect gift playback operation.

Or, the computer-readable medium carries one or more programs. When the one or more programs are executed by the electronic device, the electronic device is caused to: obtain a resource package corresponding to the target effect gift playback operation in response to the target effect gift playback operation, wherein the resource package includes: the particle data file and the parameter configuration file of the target effect gift;
load the particle data file and the parameter configuration file, and generate, by means of rendering, the target effect gift.

Computer program code for performing the operation of the present disclosure can be written in one or more programming languages or a combination thereof, and the programming languages include object-oriented programming languages, such as Java, Smalltalk, C++, and conventional procedural programming languages, such as “C” language or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer through any type of network, including a LAN or WAN, or may be connected to an external computer (e.g., connected through the Internet using an Internet service provider).

The flowcharts and block diagrams in the accompanying drawings illustrate the possible implementation architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing a specified logical function. In some alternative implementations, the functions marked in the box may also occur in an order different from that marked in the accompanying drawings. For example, two boxes represented in succession may actually be executed substantially in parallel, and they may sometimes be executed in reverse order, depending on the functions involved. Each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The units involved in the embodiments described in the present disclosure can be implemented by software or by hardware. Among them, the name of the unit does not constitute a limitation on the unit itself in one case.

The functions described above in this article can be at least partially performed by one or more hardware logic components. For example, exemplary types of hardware logic components that can be used include: Field Programmable Gate Array (FPGA), Application Specific Integrated Circuit (ASIC), Application Specific Standard Parts (ASSP), System on Chip (SOC), Complex Programmable Logic Device (CPLD), etc.

In the context of the present disclosure, a machine-readable medium can be a tangible medium that can contain or store a program for use by or in conjunction with an instruction execution system, apparatus or device. The machine-readable medium may be a machine-readable signal medium or a machine-readable storage medium. The machine-readable medium may include an electronic, magnetic, optical, electromagnetic, infrared, or semiconductor system, device or apparatus, or any suitable combination of the above. The machine-readable storage medium includes an electrical connection based on one or more lines, a portable computer disk, a hard disk, RAM, ROM, EPROM, flash memory, optical fiber, a portable CD-ROM, an optical storage device, a magnetic storage device, or any suitable combination of the above.

According to one or more embodiments of the present disclosure, Example 1 provides a livestreaming effect gift generation method, comprising:
obtaining basic data of a target effect gift, and generating a particle data file corresponding to the basic data;
generating a parameter configuration file according to the particle data file;
sending the particle data file and the parameter configuration file as a resource package of the target effect gift to a livestreaming client, so that the livestreaming client generates, by means of rendering, the target effect gift in response to the target effect gift playback operation.

According to one or more embodiments of the present disclosure, in Example 2 according to the method of claim 1, obtaining basic data of a target effect gift, and generating a particle data file corresponding to the basic data, comprises:
obtaining the basic data of the target effect gift, and processing the basic data into a grayscale picture;
extracting the target particles according to the grayscale picture;
performing coordinate normalization processing on the target particles, and packaging the information of the normalized target particles into a particle data file.

According to one or more embodiments of the present disclosure, in Example 3 according to the method of Example 2, extracting the target particles according to the grayscale picture, comprises:
scanning the pixel points in the grayscale picture, and selecting the key pixel points, the key pixel points being the pixel points with grayscale values meeting a grayscale threshold condition;
randomly selecting a specified number of key pixel points as target particles.

According to one or more embodiments of the present disclosure, in Example 4 according to the method of Example 1, generating a parameter configuration file according to the particle data file, comprises:
rendering the particle data file by using a particle rendering tool to obtain an initial effect gift;
in response to the configuration operation of the initial effect gift, determining the effect parameters of multiple target particles in the particle data file; the effect parameters include: color, size, displacement, brightness and particle level effect;
packaging the effect parameters of multiple target particles to generate a parameter configuration file.

According to one or more embodiments of the present disclosure, Example 5 provides a livestreaming effect gift generation method, comprising:
in response to the target effect gift playback operation, obtaining a resource package corresponding to the target effect gift playback operation; the resource package includes: the particle data file and parameter configuration file of the target effect gift;
loading the particle data file and the parameter configuration file, and generating, by means of rendering, the target effect gift.

According to one or more embodiments of the present disclosure, in Example 6 according to the method of Example 5, loading the particle data file and the parameter configuration file, and generating, by means of rendering, the target effect gift, comprises:
loading the particle data file and the parameter configuration file, and generating at least one effect gift rendering object;
combining at least one effect gift rendering object, and generating, by means of rendering, the target effect gift by using the particle rendering tool.

According to one or more embodiments of the present disclosure, Example 7 provides an apparatus for generating a livestreaming effect gift, comprising:
a first file generation module, configured to obtain basic data of a target effect gift and generate a particle data file corresponding to the basic data;
a second file generation module, configured to generate a parameter configuration file according to the particle data file;
a resource sending module, configured to send the particle data file and the parameter configuration file as a resource package of the target effect gift to the livestreaming client, so that the livestreaming client generates, by means of rendering, the target effect gift in response to the target effect gift playback operation.

According to one or more embodiments of the present disclosure, Example 8 provides an apparatus for generating a livestreaming effect gift, including:
a resource obtaining module, configured to obtain a resource package corresponding to the target effect gift playback operation in response to the target effect gift playback operation; the resource package includes: a particle data file and a parameter configuration file of the target effect gift;
an effect gift generation module, configured to load the particle data file and the parameter configuration file, and generate, by means of rendering, the target effect gift.

According to one or more embodiments of the present disclosure, Example 9 provides an electronic device, the electronic device comprising:
one or more processors;
a storage apparatus configured to store one or more programs,
when the one or more programs are executed by one or more processors, the one or more processors implement the livestreaming effect gift generation method as in any one of Examples 1 to 4, or implement a livestreaming effect gift generation method as in any one of Examples 5 to 6.

According to one or more embodiments of the present disclosure, Example 10 provides a storage medium containing computer executable instructions, which, when executed by a computer processor, are used to execute a livestreaming effect gift generation method as in any one of Examples 1 to 4, or implement a livestreaming effect gift generation method as in any one of Examples 5 to 6.

In addition, although multiple operations are depicted in a specific order, this should not be understood as requiring these operations to be performed in the specific order shown or in a sequential order. In certain environments, multitasking and parallel processing may be advantageous. Similarly, although multiple implementation details are included in the above discussion, these should not be interpreted as limiting the scope of the present disclosure. Some features described in the context of separate embodiments can also be implemented in combination in a single embodiment. Conversely, various features described in the context of a single embodiment may also be implemented in multiple embodiments separately or in any suitable subcombination.

Although the subject matter has been described in language specific to structural features and/or methodological logical acts, it should be understood that the subject matter defined in the appended claims is not necessarily limited to the specific features or acts described above. Rather, the specific features and acts described above are merely example forms of implementing the claims.

1. A livestreaming effect gift generation method, comprising:
obtaining basic data of a target effect gift and generating a particle data file corresponding to the basic data;
generating a parameter configuration file according to the particle data file; and
sending the particle data file and the parameter configuration file as a resource package of the target effect gift to a livestreaming client, so that the livestreaming client generates, by means of rendering, the target effect gift in response to a target effect gift playback operation.

2. The method according to claim 1, wherein the obtaining basic data of a target effect gift and generating a particle data file corresponding to the basic data comprises:
obtaining the basic data of the target effect gift, and processing the basic data into a grayscale picture;
extracting a target particle according to the grayscale picture; and
performing coordinate normalization processing on the target particle, and packaging the information of the normalized target particle into the particle data file.

3. The method according to claim 2, wherein the extracting the target particle according to the grayscale picture comprises:
scanning pixel points in the grayscale picture, and selecting key pixel points with grayscale values meeting a grayscale threshold condition; and
randomly selecting a specified number of key pixel points as the target particle.

4. The method according to claim 1, wherein the generating a parameter configuration file according to the particle data file comprises:
rendering the particle data file by using a particle rendering tool to obtain an initial effect gift;
in response to a configuration operation of the initial effect gift, determining effect parameters of multiple target particles in the particle data file; the effect parameters include: color, size, displacement, brightness and particle level effect; and
packaging the effect parameters of multiple target particles to generate the parameter configuration file.

5. A livestreaming effect gift generation method, comprising:
in response to a target effect gift playback operation, obtaining a resource package corresponding to the target effect gift playback operation; wherein the resource package includes: particle data file and parameter configuration file of a target effect gift; and
loading the particle data file and the parameter configuration file, and generating, by means of rendering, the target effect gift.

6. The method according to claim 5, wherein the loading the particle data file and the parameter configuration file, and generating, by means of rendering, the target effect gift, comprises:
loading the particle data file and the parameter configuration file, and generating at least one effect gift rendering object; and
combining the at least one effect gift rendering object, and generating, by means of rendering, the target effect gift by using a particle rendering tool.

7. (canceled)

8. (canceled)

9. An electronic device, comprising:
one or more processors;
a storage apparatus, configured to store one or more programs, and
wherein the one or more programs, when executed by the one or more processors, cause the one or more processors to
obtain basic data of a target effect gift and generating a particle data file corresponding to the basic data;
generate a parameter configuration file according to the particle data file; and
send the particle data file and the parameter configuration file as a resource package of the target effect gift to a livestreaming client, so that the livestreaming client generates, by means of rendering, the target effect gift in response to a target effect gift playback operation.

10. (canceled)

11. The method according to claim 2, wherein performing coordinate normalization processing on the target particle comprises:
determining a size of minimum enclosing interval of all target particles; and
performing coordinate normalization processing on the target particle based on the size of the minimum enclosing interval.

12. The method according to claim 11, wherein determining the size of the minimum enclosing interval of all target particles comprises:
determining a length of the minimum enclosing interval based on maximum and minimum values of horizontal coordinates of all target particles; and
determining a width of the minimum enclosing interval based on maximum and minimum values of vertical coordinates of all target particles.

13. The method according to claim 12, wherein performing coordinate normalization processing on the target particle based on the size of minimum enclosing interval comprises:
determining a first ratio based on the length of the minimum enclosing interval and length of a display area of the target effect gift in a livestreaming page;
determining a second ratio based on the width of the minimum enclosing interval and width of the display area of the target effect gift in the livestreaming page; and
performing normalization of a horizontal coordinate and a vertical coordinate of the target particle based on the first ratio and the second ratio, respectively.

14. The method according to claim 1, wherein the basic data of the target effect gift includes at least one of a picture, or a combination of text and font package, and the basic data is used to indicate a display effect of the target effect gift.

15. The method according to claim 5, wherein the particle data file includes multiple target particles for rendering the target effect gift, and the multiple target particles are specific pixels selected from a grayscale picture after grayscale processing of the basic data.

16. The method according to claim 15, wherein the parameter configuration file includes the effect parameters of multiple target particles in the particle data file, the effect parameters include: color, size, displacement, brightness and particle level effect.

17. The electronic device according to claim 9, wherein the one or more programs causing the one or more processors to obtain basic data of a target effect gift and generating a particle data file corresponding to the basic data comprise instructions to:
obtain the basic data of the target effect gift, and process the basic data into a grayscale picture;
extract a target particle according to the grayscale picture; and
perform coordinate normalization processing on the target particle, and package the information of the normalized target particle into the particle data file.

18. The electronic device according to claim 17, wherein the one or more programs causing the one or more processors to extract the target particle according to the grayscale picture comprise instructions to:
scan pixel points in the grayscale picture, and select key pixel points with grayscale values meeting a grayscale threshold condition; and
randomly select a specified number of key pixel points as the target particle.

19. The electronic device according to claim 9, wherein the one or more programs causing the one or more processors to generate a parameter configuration file according to the particle data file comprise instructions to:
render the particle data file by using a particle rendering tool to obtain an initial effect gift;
in response to a configuration operation of the initial effect gift, determine effect parameters of multiple target particles in the particle data file; the effect parameters include: color, size, displacement, brightness and particle level effect; and
package the effect parameters of multiple target particles to generate the parameter configuration file.

20. The electronic device according to claim 17, wherein the one or more programs causing the one or more processors to perform the coordinate normalization processing on the target particle comprise instructions to:
determine a size of minimum enclosing interval of all target particles; and
perform coordinate normalization processing on the target particle based on the size of the minimum enclosing interval.

21. The electronic device according to claim 20, wherein the one or more programs causing the one or more processors to determine the size of the minimum enclosing interval of all target particles comprise instructions to:
determine a length of the minimum enclosing interval based on maximum and minimum values of horizontal coordinates of all target particles; and
determine a width of the minimum enclosing interval based on maximum and minimum values of vertical coordinates of all target particles.

22. The electronic device according to claim 21, wherein the one or more programs causing the one or more processors to perform the coordinate normalization processing on the target particle based on the size of minimum enclosing interval comprise instructions to:
determine a first ratio based on the length of the minimum enclosing interval and length of a display area of the target effect gift in a livestreaming page;
determine a second ratio based on the width of the minimum enclosing interval and width of the display area of the target effect gift in the livestreaming page; and
perform normalization of a horizontal coordinate and a vertical coordinate of the target particle based on the first ratio and the second ratio, respectively.

23. The electronic device according to claim 9, wherein the basic data of the target effect gift includes at least one of a picture, or a combination of text and font package, and the basic data is used to indicate a display effect of the target effect gift.
